(19) United States
(12) Patent Application Publication
(10) Pub. No.: US 2024/0001175 A1
(43) Pub. Date: Jan. 4, 2024

(54) STRAPLESS PERSONAL RESPIRATOR

(71) Applicant: Spencer Sutherland, Spring Creek, NV (US)

(72) Inventor: Spencer Sutherland, Spring Creek, NV (US)

(21) Appl. No.: 17/856,989

(22) Filed: Jul. 2, 2022

(51) Int. Cl. A62B 18/08; A62B 23/02; A62B 9/02; A62B 9/06

(52) U.S. Cl. CPC A62B 18/084; A62B 23/02; A62B 9/022; A62B 9/06

(57) ABSTRACT

A personal breathing apparatus includes a housing having an exhaust port, at least one filter-port, and a mouth-port connecting to a mouthpiece which is held inside the user's mouth while worn. A mouthguard on the mouthpiece is claspable by the user's teeth. By design, the personal breathing apparatus is balancable at the mouthpiece, such that the portion of the apparatus outside of the user's mouth is no heavier than the portion inside the user's mouth. In this way, the apparatus can be retained only by the clenching action of the user's teeth for long periods of time with no duress to the user. No head strap or other retention fastener is required.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of filtered face masks of existing art and more specifically relates to personal breathing masks.

### RELATED ART

Personal breathing devices such as respirators are used in many industries. Government regulations have for many years required the use of respirators. Contaminants in the air have been studied and standards for particulates in the air of a workplace environment have been set. For a worker to function in a healthy environment, the use of a respirator is required. The style of respirator used in the work environment is bulky, restrictive, and only used when absolutely necessary. Furthermore, the commonly used conventional respirator is heavy, requires a shaven face, and limits visibility. Such traditional bulky respirators typically seal across the front of the face, and due to their forwardly-biased balance and excessive weight, require some sort of strap passing around the back of the head or neck to retain the respirator to the face. A suitable solution which eliminates these shortcomings is desired.

U.S. Pat. No. 7,025,060 to Alexander J. G. Nicholson relates to a personal breathing filter. The described personal breathing filter includes a personal air filtration device that has a cylindrical exhalation tube, with a one-way valve thereon. Concentric around the periphery of the exhalation tube and integrally connected to the exhalation tube rearward (proximate the user's mouth) of the one-way valve is a filter media housing. Filter media is contained between the housing and the tube. A plurality of perforations in the exhalation tube, rearward of the one way valve but forward from the housing connection ring, provide inhaled air ingress to the exhalation tube. Inhaled air forces the one-way valve closed, so that air is directed through the filter media, passes through the perforations and into the exhalation tube where the user can take in the cleansed air. The pressure of the exhaled air through the exhalation tube causes the one-way valve to open, so that exertion by the user is minimized. This patent to Nicholson is representative of previous attempts to improve traditional respirators.

### SUMMARY OF THE INVENTION

In view of the foregoing disadvantages inherent in the known personal breathing mask art, the present disclosure provides a novel personal breathing apparatus and method. The general purpose of the present disclosure, which will be described subsequently in greater detail, is to provide an effective and efficient personal breathing apparatus and method.

A personal breathing apparatus includes a housing having an exhaust port, at least one filter-port, and a mouth-port connecting to a mouthpiece which is held inside the user's mouth while worn. A mouthguard on the mouthpiece is claspable by the user's teeth. By design, the personal breathing apparatus is balanceable at the mouthpiece, such that the portion of the apparatus outside of the user's mouth is no heavier than the portion inside the user's mouth. In this way, the apparatus can be retained only by the clenching action of the user's teeth for long periods of time with no duress to the user. No head strap or other retention fastener is required. Ergonomically, the respirator is designed to be donned and doffed with one hand, with a thumb and forefinger grasping on top and on bottom of the respirator. Check valves are provided in each interior passageway connecting a filter-port or exhaust-port to the mouth-port tom prevent undesirable, unfiltered backflow. This is necessary because each port is in communication with a single common chamber adjacent to the mouth-port, and the exhaust-port is unfiltered. Therefore, in order to prevent inhalation through the exhaust-port, as well as to prevent unnecessary exhalation and introduction of moisture to the filters, check valves ensure that a user inhales through the filter-ports and exhales through the exhaust-port. In a preferred embodiment, two inlet filters straddle a single exhaust port as seen in a frontal view of the respirator. Accordingly, three total check valves are provided.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a personal breathing apparatus and method, constructed and operative according to the teachings of the present disclosure.

FIG. 1 is a front perspective view of the personal breathing apparatus during an ‘in-use’ condition, according to an embodiment of the disclosure.

FIG. 2 is a front perspective view of the personal breathing apparatus of FIG. 1, according to an embodiment of the present disclosure.

FIG. 3 is a rear perspective view of the personal breathing apparatus of FIG. 1 illustrating the mouthpiece, according to an embodiment of the present disclosure.

FIG. 4 is a top cross-sectional view of the personal breathing apparatus of FIG. 1 illustrating the interior airways, according to an embodiment of the present disclosure.

FIG. 5 is a bottom perspective view of the personal breathing apparatus, according to an embodiment of the present disclosure.

FIG. 6 is a side perspective view of the personal breathing apparatus of FIG. 1 in use, being worn by a user, according to an embodiment of the present disclosure.

FIG. 7A is a front perspective view of the personal breathing apparatus of FIG. 1 with the inlet check-valve shown disassembled, according to an embodiment of the present disclosure.

FIG. 7B is a side cutaway view of the personal breathing apparatus of FIG. 1 showing the position of interior components of the inlet check-valve, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to breathing apparatuses and more particularly to a personal breathing apparatus and method as used to improve the efficient and effective use of breathing apparatus.

Generally, the personal breathing apparatus is a light weight, minimalistic housing having multiple attachment points for filters. The apparatus replaces a conventional face-mask style respirator. The housing includes attachment points for air filters. The air filter attachment points are designed such that standardized air filters can be attached. A P-100 filter material is envisioned as an ideal filtering material, and a 3M 2097 is one preferable model of filter to be used in conjunction with the respirator. Bayonet-type filter attachments are envisioned, but other styles may be implemented. By design, a user can attach and replace any portable air filter with ease with full functionality. A mouthpiece is inserted into the mouth when worn, and has a U-shaped deformable appendage which a user may bite upon to retain the respirator in their mouth. Sea-Cure is seen as an optimal material for the deformable appendage of the mouthpiece. In some embodiments, the mouthpiece may be weighted to balance the respirator assembly. Such a method of retention is desirable, because with the teeth clenched in this way, it has been found that the user salivates less while wearing the respirator. Additionally, the mouthpiece appendage is sufficiently deformable that it can be easily formed for users having differently sized mouths, and the provision of different sizes, or burdensome fitting, is not necessary. Centrally to the U-shaped mouthpiece appendage, and facing into the opening of the U-shape, is an aperture which is in communication with the interior channels of the respirator, and it is through this aperture that the user inhales and exhales. Sealing of the mouth to the respirator is enacted entirely by the closing of the user's lips. Advantageously, this means that no external fitting of the respirator to the user's face is necessary, and the respirator is easily usable by users with abnormally shaped faces, as well as bearded individuals. Furthermore, because the respirator does not hug about the top of the user's nose, sufficient clearance is given to wear fully protective Z87 eyewear. The reduced surface contact of the respirator to skin improves comfort of the user, especially in hot environments, as the respirator will not retain heat against the user's face.

Preferably, no airflow communication with the nostrils are provided. Rather, a noseclip may be affixed to the top of the respirator housing, which may be positioned over the bridge of the nose in use, clamping on either side of the nose to close the nostrils. This function ensures that all inhalation and exhalation is passed through the mouthpiece of the respirator. Additionally, the noseclip may provide some additional stability to the respirator on the user's face, although this is deemed an optional feature, and not always necessary to the effective use of the respirator.

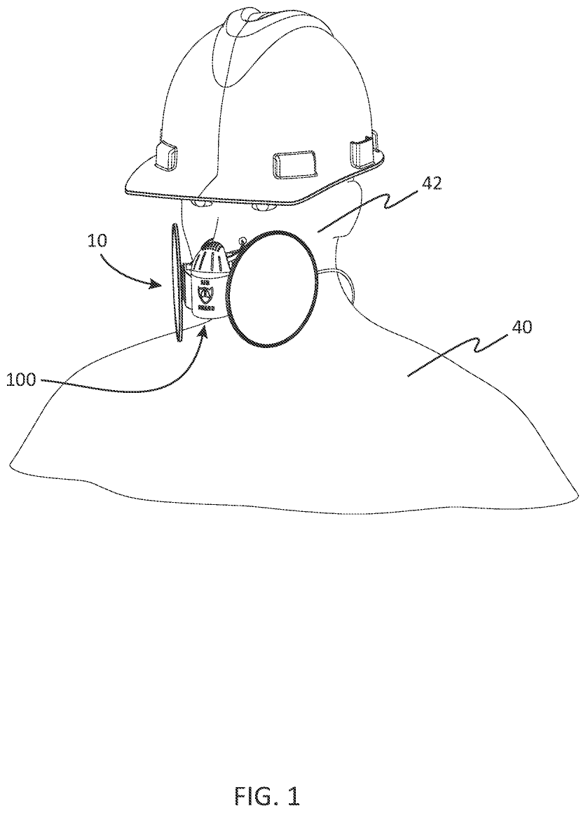

Referring now more specifically to the drawings by numerals of reference, there is shown in FIGS. 1-7B, various views of a personal breathing apparatus 100.

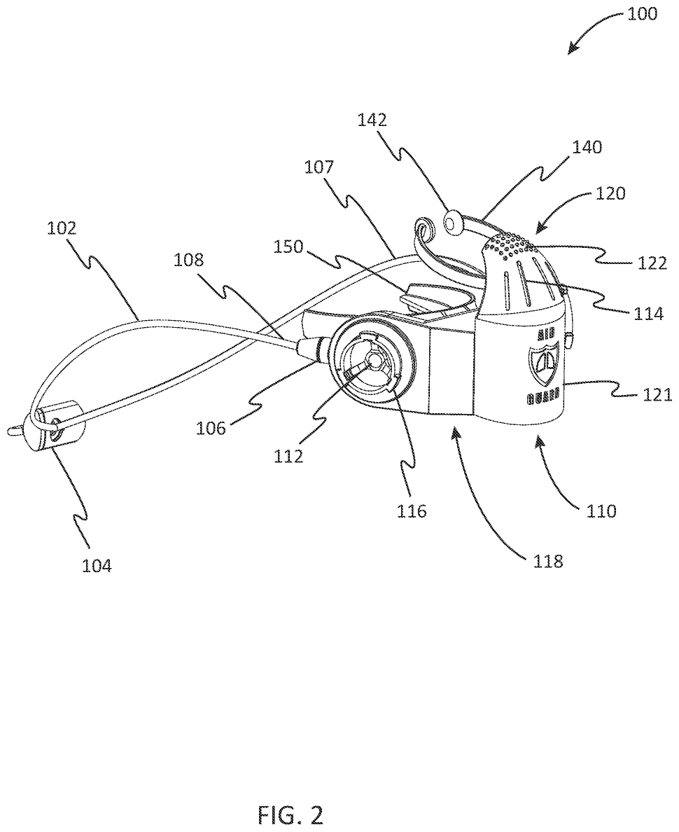

FIG. 1 shows a personal respirator during an ‘in-use’ condition, according to an embodiment of the present disclosure. Personal respirator 100 may be worn by user 40 over the face 42. Filters 10 may be affixed to personal respirator 100 to filter air being inhaled by user 40. Preferably, no gaskets are provided to seal filter 10 to personal respirator 100, but the compression of filter 10 to housing 110 (FIG. 2) is sufficient to seal filter 10 to personal respirator 100.

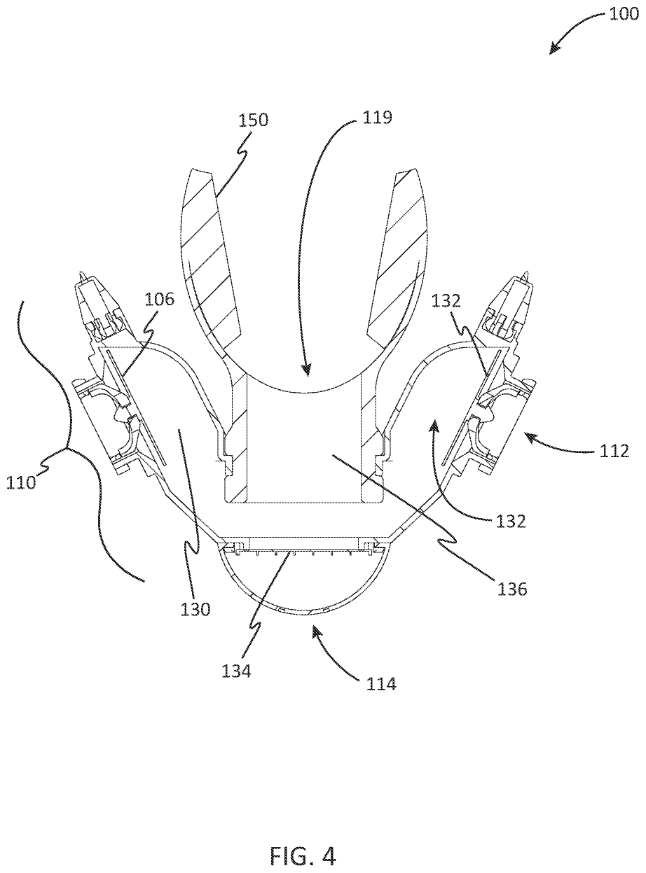

FIG. 2 shows the personal breathing apparatus 100 of FIG. 1, according to an embodiment of the present disclosure. Personal respirator 100 may include housing 110 and mouthpiece 150. Housing 110 may be characterized by exhaust-port 114, at least one filter-port 112, and mouth-port 119 (FIG. 4). Housing 110 may internally be characterized by one or more interconnected hollow passageways (see FIG. 4) connecting each of at least one filter-port 112 and exhaust-port 114 with mouth-port 119 (FIG. 4), mouth-port 119 being integrated with mouthpiece 150. At least one filter-port 112 may also be referred to as the inhalation port, since all inhalation of user 40 (FIG. 1) will enter respirator 100 through at least one filter-port 112 when respirator 100 is worn by user 40 (FIG. 1).

As illustrated in FIG. 1 in a usable, filtering condition, at least one filter 10 (FIG. 1) is releasably attachable to at least one filter-port 112. Here in FIG. 2 at least one filter-port 112 is illustrated exposed, without filter 10 (FIG. 1) attached. In some embodiments, at least one filter port 112 is externally characterized by bayonet connectors 116 as shown. Preferably, bayonet connectors 116 are a triad of outwardly-facing tabs that are each separated from each other by 120-degrees on center, and are sized and arranged such that a filter 10 (FIG. 1) (such as a 3M 2097 type filter) may be attached by pressing the filter 10 (FIG. 1) onto the at least one filter port 112 and rotating it until filter 10 (FIG. 1) is locking into the tabs of bayonet connector 116. Here, housing 110 may form a pair of lateral sides 118 to the left and right, forming wings which extend to the left and right sides respectively of the face of the user 40 (FIG. 1) when worn. These wings may be characterized by corresponding wings of the interior passageways as well. To these lateral sides 118, at least one filter-ports 112 may be embedded, advantageously placing the filters 10 (FIG. 1) to the sides of the face of user 40 (FIG. 1) when worn.

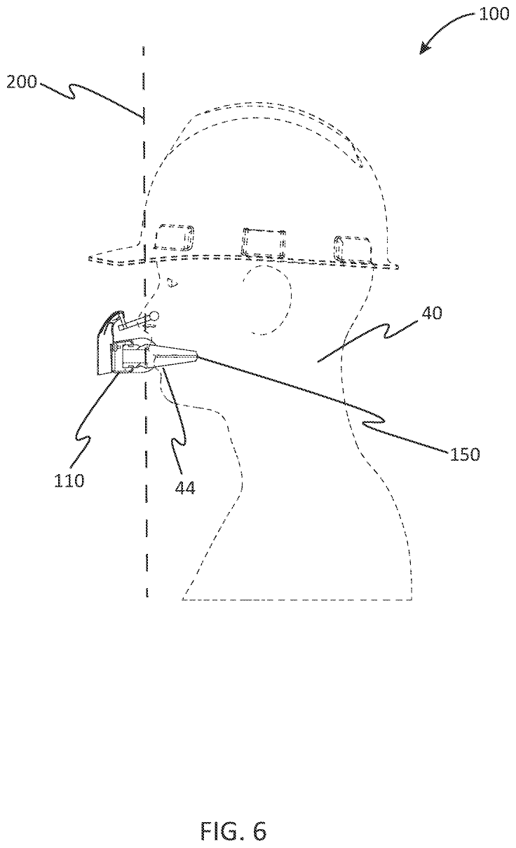

Housing 110 may be constructed of resin. Resin has been found as an ideal material for constructing housing 110 for weight distribution purposes; however, other materials such as polymers, rubber, and silicone may also be used so long as the weight distribution does not bias the center of gravity of the respirator in front of the mouthpiece. Resin has been found to have a sufficiently high strength-to-weight ratio that the housing may be constructed light enough to not overbalance mouthpiece 150. See FIG. 6 for illustrations of weight distribution characteristics.

Respirator 100 may further comprise upper shield 120, which may be unitary to or attached to housing 110. Upper shield 120 may be disposed over the nose of user 40 (FIG. 1) when worn. Preferably, upper shield 120 may include knurling 122, providing a structurally rigid and tactile spot for a user to grasp respirator 100 when donning and doffing. In some embodiments, exhalation port 114 may perforate upper shield 120. However, in other embodiments, exhalation port 114 may simply perforate housing 110, being concealed by upper shield 120 and front shield 121. In such an embodiment, slots may perforate upper shield 120, and front shield 121 may simply cover an airspace such that concealed exhalation port 114 communicates freely with the slots of upper shield 120. Furthermore, upper shield 120 may provide a structurally sound mounting point for nose clamp arms 140.

Respirator 100 may include a nose clamp affixed to an upper end of housing 110 proximate to or connected to upper shield 120. Nose clamp may include a pair of curved arms 140 as shown, mirrored over a center line of respirator 100 from a frontal view, and being outwardly convex, such that the left and right arms of the pair of curved arms 140 circle around the left and right sides of the nose of user 40 (FIG. 1) respectively. Curved arms 140 are resilient but sufficiently springy to be opened wide to fit around the nose when donned, and then apply pressure to both sides of the nose simultaneously when worn, applying pressure directly over the nasal cavity interior to the nose. Nose clamp ends 142 are affixed to the termini of curved arms 140 and provide a wider cushioned surface able to apply pressure more comfortably to the nose. Nose clamp ends 142 are preferably dome-shaped and may be constructed of a soft elastic material such as rubber or silicone for superior comfort.

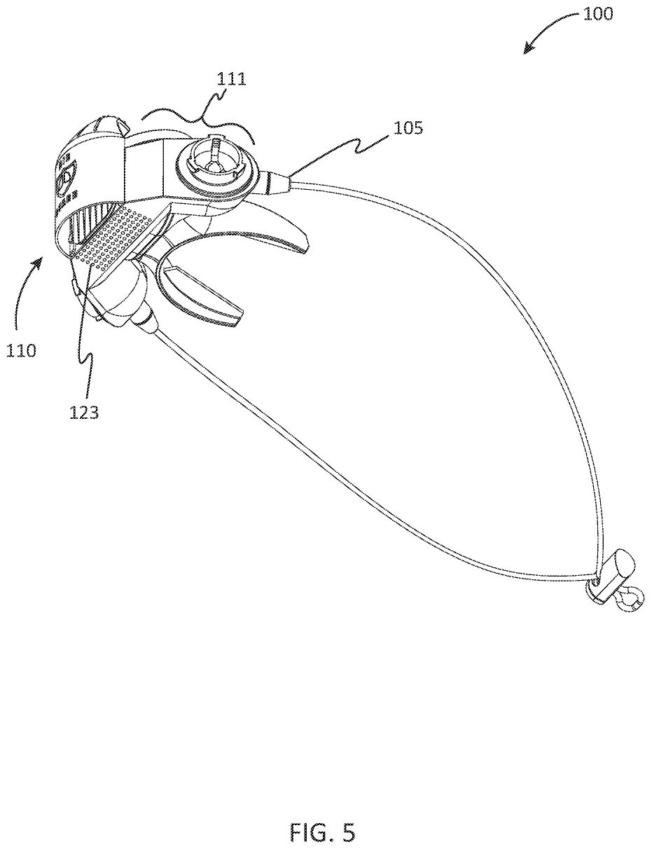

Housing 110 may also include a left-breakaway socket 105 (FIG. 5) and a right-breakaway socket 106, as well as lanyard 102. Lanyard 102 may have a left-end 107 able to fasten to the left-breakaway socket 105 (FIG. 5) and a right-end 108 able to fasten to the right-breakaway socket 106, such that the left-end 107 detaches from the left-breakaway socket 105 (FIG. 5) when subjected to a tension of a predetermined force. In one embodiment, the predetermined force may be five pounds or greater. Likewise, the right-end 108 detaches from the right-breakaway socket 106 when subjected to a tension of the predetermined force. Lanyard 102 may also include cord retainer 104 having a button to release tension from lanyard 102, such that lanyard 102 may be lengthened or shortened according a wearer's preference. It should be noted that lanyard 102 is not intended to retain respirator 100 to the face of the user 40 (FIG. 1) when worn, and should not be fully tightened to the back of the neck when worn. As shown, lanyard 102 is connected too low on housing 110 to effectively perform this type of retention, as housing 110 is weighted too high and would pitch forward when worn if this was the retention mechanism. Rather, respirator 100 is retained to user 40 (FIG. 1) only by the clenching of the teeth and lips on mouthpiece 150, and respirator 100 is so balanced as to be able to be retained this way without effort; specifically, the balance point of respirator 100 (front-to-back) is at the front of mouthpiece 150, at the lips of user 40 (FIG. 1). Due to this balance, respirator 100 is not biased to pitch forward when held by the teeth. The sole purpose of lanyard 102 is to hang respirator 100 about the neck of user 40 (FIG. 1) when not worn, such that user 40 (FIG. 1) need not worry about losing respirator 100 to misplacement or damage when not being used.

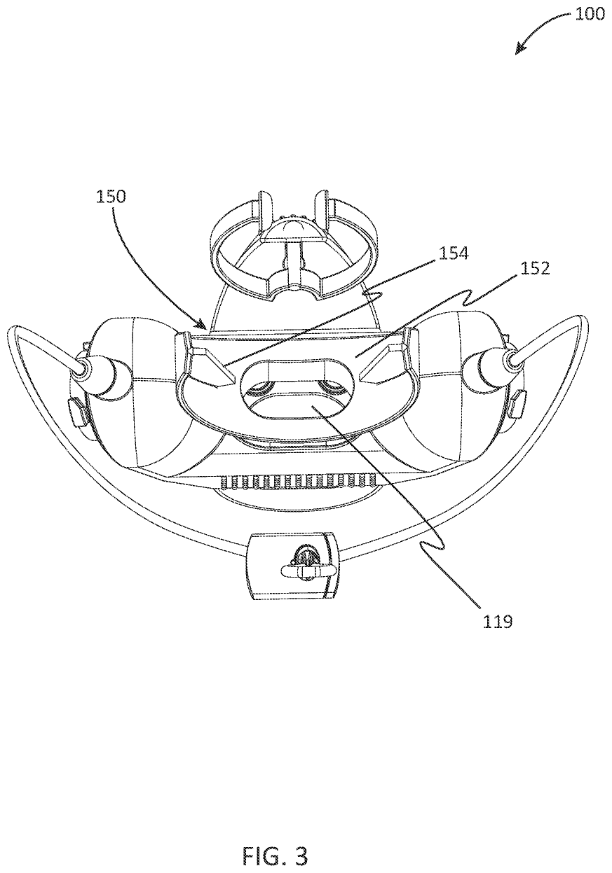

FIG. 3 is a rear view of the respirator 100 illustrating the mouthpiece 150. Mouthpiece 150 may itself be characterized by tooth-guard 152, tooth-shelf 154, and mouth-port 119. Tooth-guard 152 may be shaped as a strip curved into an arc, encircling and covering the front of the teeth. Tooth-shelf 154 may project interiorly to the arc from tooth-guard 152, and at a normal angle to tooth-guard 152, vertically central to tooth-guard 152, such that tooth-shelf 154 is claspable between the teeth of a user when the teeth are clenched. Tooth-guard 152 and tooth-shelf 154 may be formed of an elastic and deformable material such as rubber or silicone.

FIG. 4 is a top cross-sectional view of respirator 100. As shown, housing 110 may internally be characterized by one or more interconnected hollow passageways 130 including inlet-passage 132, outlet-passage 134, and breathing-passage 136. In a preferred embodiment, each of inlet-passage 132, outlet-passage 134, and breathing-passage 136 may be a unitary and continuous airspace. Inlet-passage 132 may correspond to (being proximate to and in direct communication with) each at least one filter-port, being able to deliver air from at least one filter-port 112 to mouth-port 119, having checkvalve 160 embedded in at least one filter-port 112 in order to prevent backflow of air from mouth-port 119 of at least one filter-port 112.

Outlet-passage 134 may correspond to (being proximate to and in direct communication with) exhaust-port 114, being able to deliver air from mouth-port 119 to exhaust-port 114, having exhaust-valve 134 installed within or behind exhaust-port 114, preventing inflow from exhaust-port 114 to mouth-port 119.

In this way, air flows selectively in through inlet-passage 132, or out through outlet-passage 134, based simply on whether the user is inhaling or exhaling respectively, this selective action being controlled by the unidirectional nature of checkvalve 160 and exhaust-valve 134 respectively.

Mouthpiece 150 is anatomically shaped to create an air-tight seal to a user's mouth, mouthpiece 150 being affixed to or unitary with mouth-port 119, mouthpiece 150 being connected to breathing-channel 136, which itself is configured for the passage of breathable air. Breathing-channel 136 of interconnected hollow passageways 130 within mouthpiece 150 is simultaneously connected to inlet-passage 132 and outlet-passage 134. Inlet-passage 132 and outlet-passage 134 may be a unitary airspace, the unitary airspace having a C-shape, such that each terminus of the C-shape comprises one of at least one filter-port 112, and exhaust-port 114 is disposed at a center of the C-shape on the convex side, and mouth-port 119 is disposed at the center of the C-shape on the concave side. This shape, in an ideally envisioned embodiment, is illustrated.

FIG. 5 is a bottom perspective view of respirator 100. Left-breakaway socket 105 is shown affixed to a terminus of lateral wing 111 of housing 110. Lower knurling 123 on bottom of housing 110 is also shown.

FIG. 6 is a side perspective view of the personal respirator 100 in use, being worn, by user 40. As shown, personal respirator 100 may be worn and retained within the mouth of user 40 without any fastening devices such as a neck or headstrap. Housing 110 may be no more than fifty percent of the weight of personal respirator 100. Furthermore, personal respirator 100 is balanceable no further towards exhaust-port 114 (FIG. 2) than mouth-port 119 (FIG. 2), such that if mouthpiece 150 is held within the mouth 44, then the weight of housing 110 does not bias the personal breathing apparatus towards falling out of the mouth 44. As shown, axis of balance 200 is placed approximately at the lips of user 40 when worn.

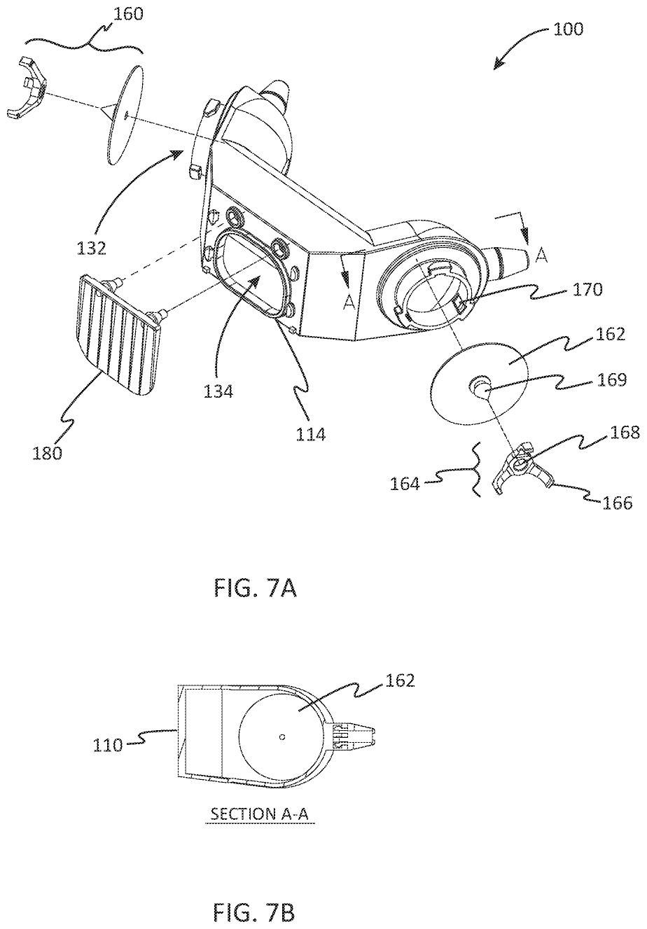

FIG. 7A is a front perspective view of the personal respirator 100 with checkvalve 160 shown disassembled. Checkvalve 160 may include flat and circular elastic membrane 162, trident-frame 164, and valve-fastener 169. Flat and circular elastic membrane 162 may also be referred to as a with membrane or disk. Trident-frame 164 is a unitary component characterized three arms 166 and aperture 168. Each of three arms 166 able to slide into a corresponding slot 170 of filter-port 112, each of three arms 166 being parallel with each other and each three of the slot being parallel with each other. Trident-frame 164 may be an injection-molded polymer component. Valve-fastener 169 may be affixed centrally to (or be unitary with) flat and circular elastic membrane 162 and may be fastenable to aperture 168. Valve-fastener may be a conical projection with a narrower shaft connecting the conical projection to the circular elastic membrane 162, the conical projection being sufficiently deformable to be pushed through aperture 168, whereupon it expands and resists rearward withdrawl from aperture 169.

When flat and circular elastic membrane 162 is fastened by valve-fastener 169 to trident-frame 164, and trident-frame 164 is inserted into filter-port 112, flat and circular elastic membrane 162 covers and closes filter-port 112 against fluid communication with inlet-passage 132, such that when a vacuum is applied to inlet-passage 132, the flat and elastic circular elastic membrane will deform about the circumference and open filter-port 112 to fluid communication with inlet-passage 132. Flat and circular elastic membrane 162 is constructed of rubber, silicone, or another similarly deformable and elastic material which will naturally hold a flat and sealed position within checkvalve 160.

Exhaust-valve 134 may include rectangular panel 180 able to cover exhaust-port 114 and close and seal exhaust-port 114 from fluid communication with outlet-passage 134, rectangular panel 180 being able to hinge upon an edge to open exhaust-port 114 to fluid communication with outlet-passage 134 when a pressure is applied to outlet-passage 134, whereby rectangular panel 180 is only able to hinge open away from exhaust-port 114, such that a pressure applied exteriorly to outlet-passage 134 will not open exhaust-port 114 to fluid communication with outlet-passage 134. Studs may be attached to or may be integral to rectangular panel 180, and may be insertable into bores in housing 110. However, the fitment of the bores to the studs must be sufficiently flexible to enable articulation of rectangular panel 180 over exhaust-port 114. This function may be further enacted by rounded or bulbous ends on the ends of the studs interfacing with rubber grommets within the bores. However, other retention and articulation mechanisms may be implemented.

FIG. 7B illustrates the position of flat and circular elastic membrane 162 within housing 110 from a side cutaway view.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A personal respirator comprising:
a housing having an exhaust-port, at least one filter-port, and a mouth-port, the housing having
an inlet-passage corresponding to each at least one filter-port able to deliver air from the at least one filter-port to the mouth-port having a checkvalve preventing backflow of air from the mouth-port of the at least one filter-port;
an outlet-passage corresponding to the exhaust-port able to deliver air from the mouth-port to the exhaust-port having an exhaust-valve preventing inflow from the exhaust-port to the mouth-port;
a mouthpiece, said mouthpiece is anatomically shaped to create an air-tight seal to a user's mouth, said mouthpiece is configured to attach to said mouth-port, said mouthpiece includes a breathing-channel configured for the passage of breathable air
a chamber within the mouthpiece simultaneously connected the inlet-passage and the outlet-passage;
at least one filter, said at least one filter is configured to attach to said at least one filter-port,
wherein the housing is no more than fifty percent of the weight of the personal respirator; and
wherein the personal respirator is balanceable no further towards the exhaust-port than the mouth-port, such that if the mouthpiece is held within the mouth, then the weight of the housing does not bias the personal breathing apparatus towards falling out of the mouth.

2. The personal respirator of claim 1, wherein the mouthpiece further comprises
a toothguard formed as a strip curved into an arc; and
a tooth-shelf projecting interiorly to the arc from the toothguard, such that the tooth-shelf is claspable between the teeth of a user;
wherein the toothguard and the tooth-shelf are formed of an elastic and deformable material.

3. The personal respirator of claim 1, wherein the housing is constructed of resin.

4. The personal respirator of claim 1, wherein the checkvalve comprises
a flat and circular elastic membrane;
a trident-frame having three arms and an aperture, each of the three arms able to slide into a corresponding slot of the filter-port, each of the three arms being parallel with each other and each three of the slot being parallel with each other;
a valve-fastener affixed centrally to the flat and circular elastic membrane and able to fasten to the aperture;
such that when the flat and circular elastic membrane is fastened by the valve-fastener to the trident-frame, and the trident-frame is inserted into the filter-port, the flat and circular elastic membrane covers and closes the filter-port against fluid communication with the inlet-passage; and
such that when a vacuum is applied to the inlet-passage, the flat and elastic circular elastic membrane will deform about the circumference and open the filter-port to fluid communication with the inlet-passage.

5. The personal respirator of claim 1, wherein the flat and circular elastic membrane is constructed of rubber.

6. The personal respirator of claim 1, wherein the flat and circular elastic membrane is constructed of silicone.

7. The personal respirator of claim 1, wherein the exhaust-valve comprises
a rectangular panel able to cover the exhaust-port and close the exhaust-port from fluid communication with the outlet-passage, the rectangular panel being able to hinge upon an edge to open the exhaust-port to fluid communication with the outlet-passage when a pressure is applied to the outlet-passage;
whereby the rectangular panel is only able to hinge open away from the exhaust-port, such that a pressure applied exteriorly to the outlet-passage will not open the exhaust-port to fluid communication with the outlet-passage.

8. The personal respirator of claim 1, wherein the housing further comprises
a left-breakaway socket and a right-breakaway socket.

9. The personal respirator of claim 8, further comprising
a lanyard having a left-end able to fasten to the left-breakaway socket and a right-end able to fasten to the right-breakaway socket, such that the left-end detaches from the left-breakaway socket when subjected to a tension of ten pounds or greater, and such that the right-end detaches from the right-breakaway socket when subjected to a tension of ten pounds or greater.

10. The personal respirator of claim 1, wherein the inlet-passage and the outlet-passage are a unitary airspace, the unitary airspace having a C-shape, such that each terminus of the C-shape comprises one of the at least one filter-port, and the exhaust-port is disposed at a center of the C-shape on the convex side, and the mouth-port is disposed at the center of the C-shape on the concave side.

11. The personal respirator of claim 1, wherein the housing is spaced at least one-half of an inch from the top of the bridge of the nose to provide sufficient clearance for wearing eye protection.

12. The personal respirator of claim 1, wherein the housing is constructed of one or more materials selected from the group consisting of resin, plastic, and rubber.

13. A personal respirator comprising:
a housing having an exhaust-port, at least one filter-port, and a mouth-port, the housing having
an inlet-passage corresponding to each at least one filter-port able to deliver air from the at least one filter-port to the mouth-port having a checkvalve preventing backflow of air from the mouth-port of the at least one filter-port;
an outlet-passage corresponding to the exhaust-port able to deliver air from the mouth-port to the exhaust-port having an exhaust-valve preventing inflow from the exhaust-port to the mouth-port;
a mouthpiece, said mouthpiece is anatomically shaped to create an air-tight seal to a user's mouth, said mouthpiece is configured to attach to said mouth-port, said mouthpiece includes a breathing-channel configured for the passage of breathable air a chamber within the mouthpiece simultaneously connected the inlet-passage and the outlet-passage;
at least one filter, said at least one filter is configured to attach to said at least one filter-port,
wherein the housing is no more than fifty percent of the weight of the personal respirator;
wherein the personal respirator is balanceable no further towards the exhaust-port than the mouth-port, such that if the mouthpiece is held within the mouth, then the weight of the housing does not bias the personal breathing apparatus towards falling out of the mouth;
wherein the checkvalve comprises a flat and circular elastic membrane;
wherein the exhaust-valve comprises a rectangular panel able to cover the exhaust-port and close the exhaust-port from fluid communication with the outlet-passage, the rectangular panel being able to hinge upon an edge to open the exhaust-port to fluid communication with the outlet-passage when a pressure is applied to the outlet-passage; and
whereby the rectangular panel is only able to hinge open away from the exhaust-port, such that a pressure applied exteriorly to the outlet-passage will not open the exhaust-port to fluid communication with the outlet-passage.
